(19) United States
(12) Patent Application Publication
(10) Pub. No.: US 2026/0183799 A1
(43) Pub. Date: Jul. 2, 2026

(54) AIR KNIFE WITH DIVERGING FINS FOR UNIFORM AIR FLOW DISTRIBUTION

(71) Applicant: WEBSTER ACTION EQUIPMENT COMPANY, INC., Newberg, OR (US)

(72) Inventor: Chad Hughes, Newberg, OR (US)

(21) Appl. No.: 19/427,312

(22) Filed: Dec. 19, 2025

Related U.S. Application Data
(60) Provisional application No. 63/739,257, filed on Dec. 27, 2024.

(51) Int. Cl. B07B 4/00

(52) U.S. Cl. CPC B07B 4/00

(57) ABSTRACT

An air knife device includes a base plenum having a side inlet configured to receive pressurized fluid from an air source coupled thereto and a discharge chamber coupled to the base plenum and in fluid communication with the base plenum. The discharge chamber including a first plate, a second plate having a plurality of fins, and a pair of sidewalls coupling the first plate to the second plate. The first plate and the second plate converge to form an air knife discharge portion where the fins direct the pressurized fluid to the air knife discharge portion for release therefrom. The fins are arranged symmetrically at angles on the second plate relative to an axis (A) to reduce pressure imbalances, and create a diverging airflow path for uniform distribution of the pressurized fluid within the discharge chamber. The device may be integrated into a materials separating system to separate mixed materials.

### CROSS-REFERENCE TO RELATED APPLICATIONS

This application claims the benefit of U.S. Provisional Application No. 63/739,257, filed on December 27, 2024. The entire disclosure of the above application is incorporated herein by reference.

### FIELD

The present technology relates to air flow distribution systems and, more particularly, to air knives having internal flow control features for achieving uniform air flow distribution..

### INTRODUCTION

This section provides background information related to the present disclosure which is not necessarily prior art.

An air separation system, often referred to as an air knife, may be used in an industrial application for material classification and separation to direct air flow for separating a batch of materials. More specifically, the air knife may utilize a controlled flow of pressurized air to separate the batch of materials having different densities and/or different weights. Achieving consistent and reliable separation of the batch of materials may be challenging and may also depend on a location or positioning of an air inlet of the air knife device. Positioning the air inlet of the air knife device on a top or bottom portion of the air knife device may include certain limitations such as inconsistent air velocity distribution. An additional limitation may include turbulent or unstable air flow through the air knife device exiting therefrom across a width of an outlet of the air knife device, which may compromise the effectiveness of the material separation process. The air may be directed through the top or bottom portion of the air knife device with no internal features assisting or guiding the air flow. This configuration may result in increased pressure within the air knife body causing the air to exit through the outlet of the air knife device with an inconsistent air flow distribution across the width of the outlet.

The air knife device having the top or bottom air inlets may lead to inconsistent air flow which may create operational inefficiencies. As air may be directed through the inlet of the air knife, the resulting uneven air flow pattern may cause variations in separation performance. In turn, this may directly impact the purity of the output stream during a material separation process, resulting in inconsistent separation of the batch of materials.

The air separation system may also face challenges in maintaining precise control over material fractions during separation. The asymmetrical air flow distribution may provide difficulties in achieving accurate tuning adjustments, often resulting in either inadequate separation or excessive waste of desirable materials. This may impact the ability to meet contamination requirements while maintaining operational efficiency.

The internal geometry of the air knife may present additional challenges such as a lack of adequate mechanisms to properly direct and balance the air flow from the inlet to the discharge point, resulting in inconsistent performance and reduced efficiency in industrial applications. The imbalance of air flow in the air knife due to the internal geometry configuration may also lead to an increased pressure drop across the air knife or the creation of dead zones where air flow becomes stagnant.

There is a continuing need for an improved air knife device that may effectively manage air flow distribution from a side inlet configuration receiving air flow therethrough. Desirably, such an air knife device would provide uniform air flow distribution across an entire length of the air knife device while militating against pressure imbalances, optimizing the use of plenum space, and maintaining consistent performance while minimizing the complexity and cost of the manufacturing processes.

### SUMMARY

In concordance with the instant disclosure, an improved air knife device that may effectively manage air flow distribution from a side inlet configuration receiving air flow therethrough, provides uniform air flow distribution across an entire length of the air knife device while militating against pressure imbalances, optimizing the use of plenum space, and maintaining consistent performance while minimizing the complexity and cost of the manufacturing processes, has surprisingly been discovered.

The present technology includes articles of manufacture, systems, and processes that relate to air knives having side inlets and internal flow control features including restricting baffles, center fins, and symmetrically arranged diverging fins for achieving uniform air flow distribution.

In certain embodiments, an air knife device may be provided. The air knife device may include a base plenum having a side inlet configured to receive pressurized fluid from an air source coupled thereto. The air knife device may further include a discharge chamber coupled to the base plenum and in fluid communication with the base plenum. The discharge chamber may include a first plate, a second plate having a plurality of fins disposed thereon, and a pair of sidewalls coupling the first plate to the second plate. The first plate and the second plate may converge to form an air knife discharge portion where the plurality of fins may direct the pressurized fluid to the air knife discharge portion for release therefrom.

In certain embodiments, a materials separating system may be provided. The materials separating system may include the air knife device as described herein and an air source including a blower. The blower may be configured to release pressurized fluid therefrom. The blower may be coupled to the side inlet of the base plenum of the air knife device. The materials separating system may include a material separating machine. The material separating machine may be configured to receive a batch of mixed materials for separation thereof and may be in fluid communication with the blower where the blower may be configured to direct the pressurized fluid through the air knife device. The pressurized fluid may exit the air knife discharge portion of the air knife device to separate the batch of mixed materials received from the material separating machine.

In certain embodiments, a method of separating materials may be provided. The method may include a step of providing a materials separating system as described herein including the air knife device. The method may include a step of coupling the air source to the side inlet of the base plenum. The method may include a step of distributing the pressurized fluid through the discharge chamber and a step of releasing the pressurized fluid from the air knife discharge portion for separating the batch of mixed materials.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a top perspective view of an air knife device according to an embodiment of the present disclosure.

FIG. 2 is a bottom perspective view perspective view of the air knife device shown in FIG. 1.

FIG. 3 is a front elevational view of the air knife device shown in FIG. 1.

FIG. 4 is a rear elevational view of the air knife device shown in FIG. 1.

FIG. 5 is a left side elevational view of the air knife device shown in FIG. 1.

FIG. 6 is a right side elevational view of the air knife device shown in FIG. 1.

FIG. 7 a top plan view of the air knife device shown in FIG. 1.

FIG. 8 is a bottom plan view of the air knife device shown in FIG. 1.

FIG. 9 is a partial exploded rear view of the air knife device shown in FIG. 1.

FIG. 10 an exploded view of the air knife device shown in FIG. 1.

FIG. 11 is a partial assembly view of the air knife device shown in FIG. 1 with a first plate removed.

FIG. 12 is a front elevational view of the air knife device shown in FIG. 11.

FIG. 13 is a top perspective view of the air knife device shown in FIG. 11.

FIG. 14 is an enlarged perspective view of a mesh plate of the air knife device shown in FIG. 11.

FIG. 15 is an environmental view of a materials separating system including an air knife device, according to an embodiment of the present disclosure.

FIG. 16 is a perspective sectional view of an air knife device according to another embodiment of the present disclosure, particularly illustrating a flow of pressurized air through the air knife device from a side inlet and out an air knife discharge portion.

FIG. 17 is a flowchart illustrating a method of separating a batch of materials, according to yet another embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1–10, or 2–9, or 3–8, it is also envisioned that Parameter X may have other ranges of values including 1–9, 1–8, 1–3, 1–2, 2–10, 2–8, 2–3, 3–10, 3–9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

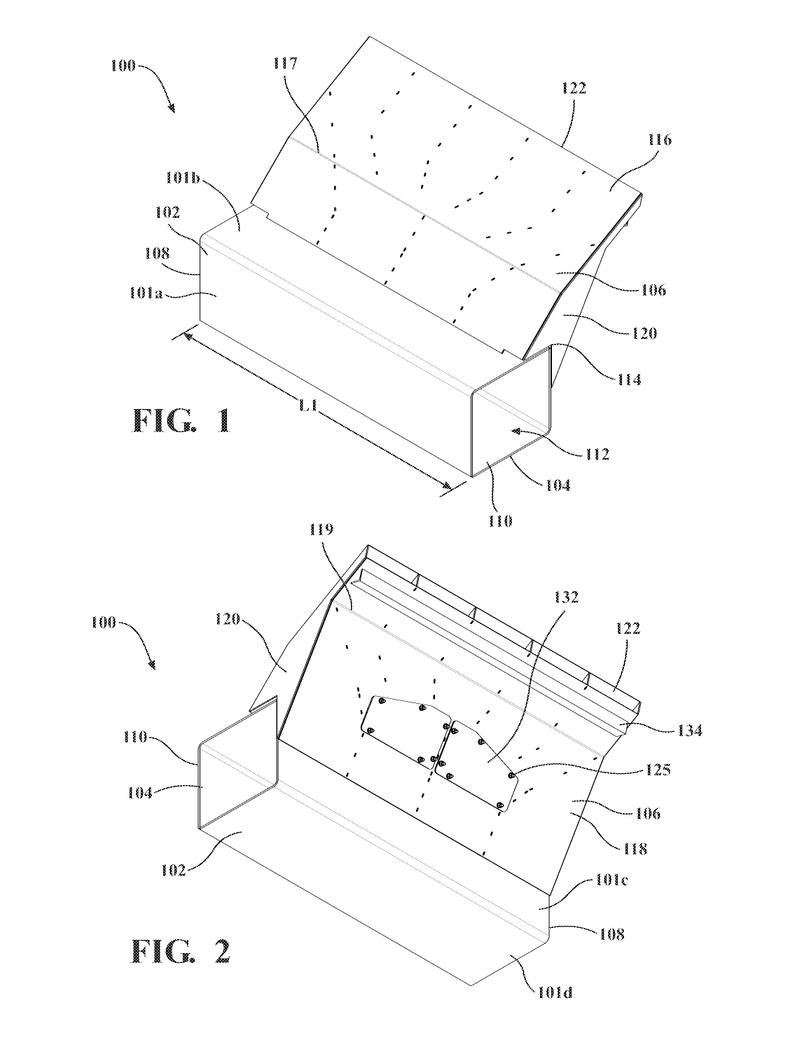

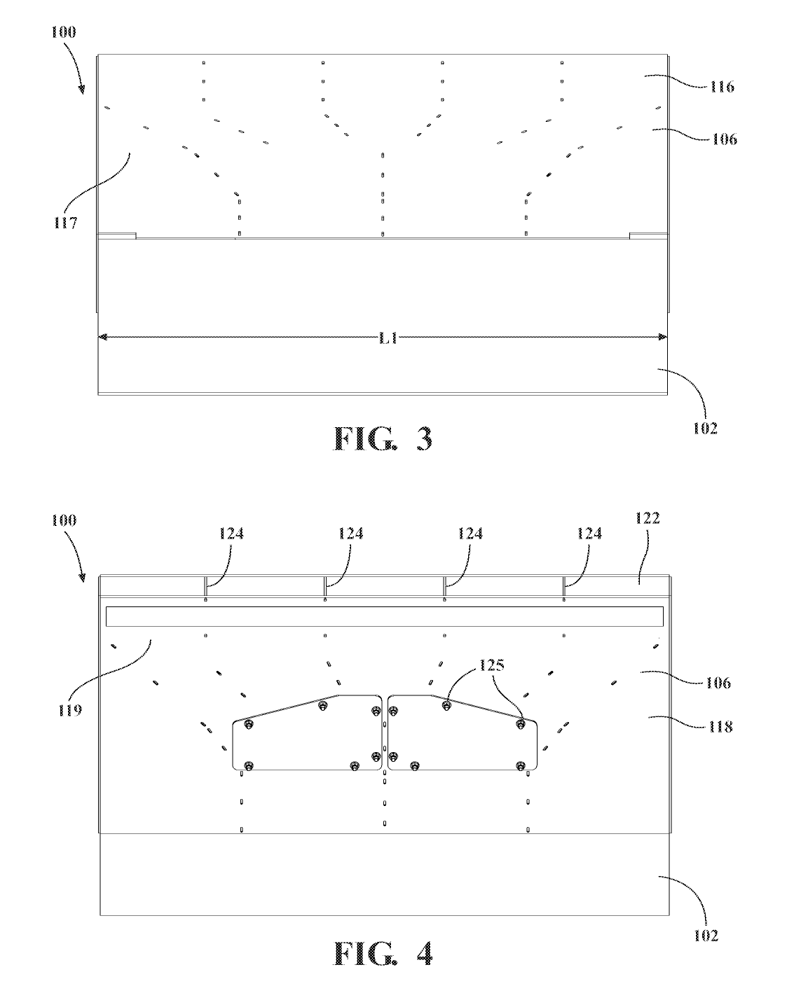

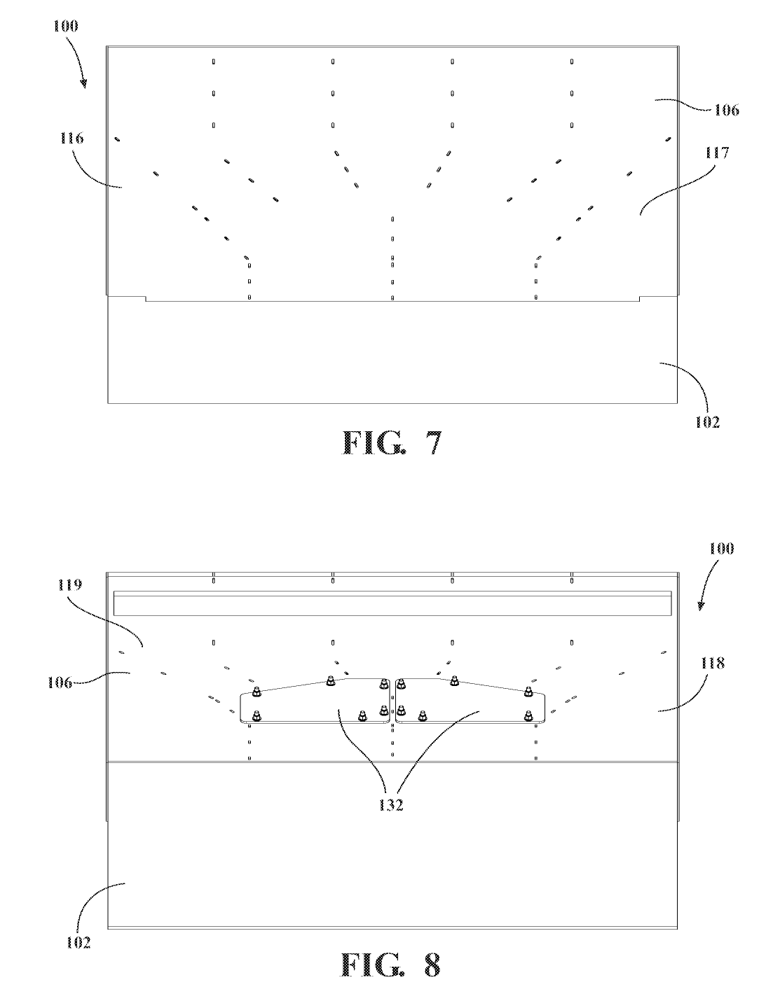

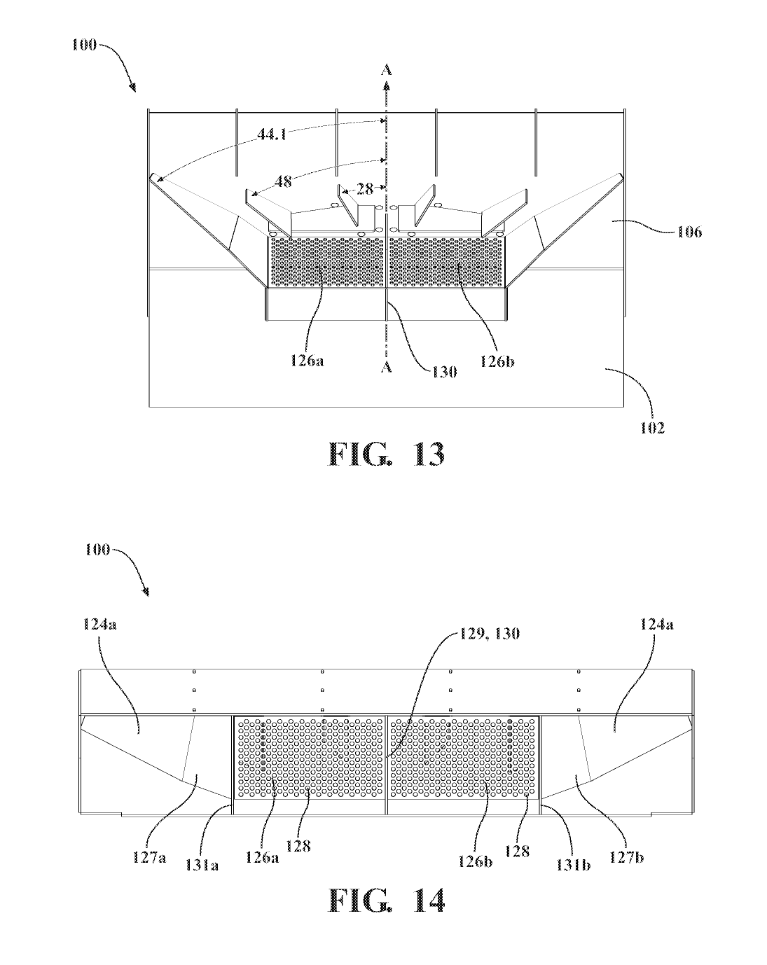

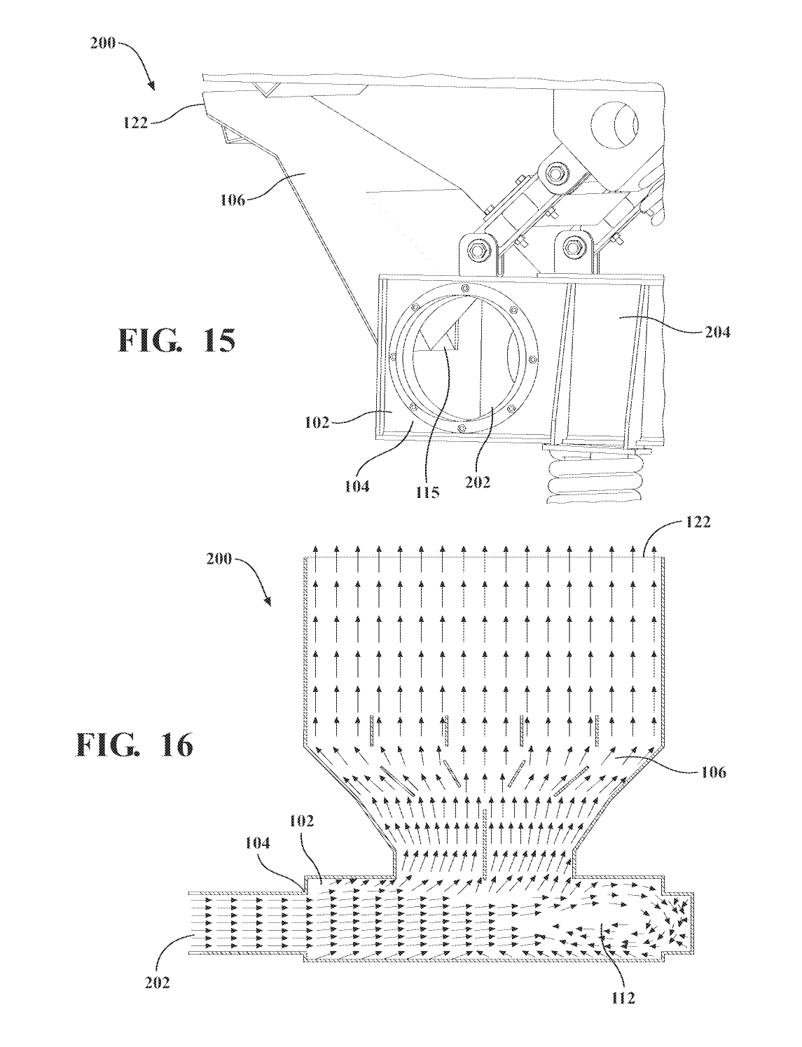

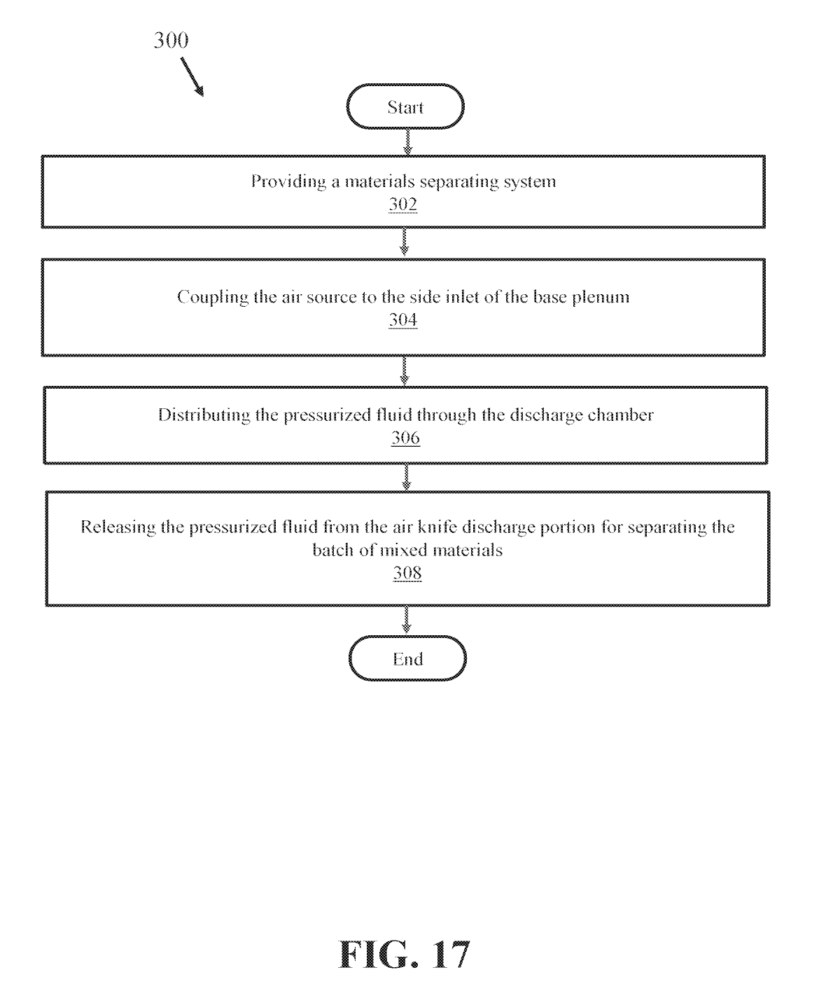

In certain embodiments of the present disclosure, an air knife device 100 may be provided, with reference to FIGS. 1-14. In certain embodiments of the present disclosure, a materials separating system 200 may be provided using the air knife device 100, as shown in FIG. 15-16. In certain embodiments, a method 300 of separating a batch of materials may also be provided, as shown in FIG. 17. Advantageously, the air knife device 100 may provide an internal symmetrical configuration for enhanced air flow control to effectively manage air flow distribution, reduce pressure imbalances, and create uniform air flow patterns exiting the air knife device 100.

With reference to FIGS. 1-14, the air knife device 100 may include a base plenum 102 having a side inlet 104 and a discharge chamber 106 where the base plenum 102 may receive pressurized air and be in fluid communication with the discharge chamber 106 to release the pressurized fluid for separating a batch of materials. The pressurized fluid may be received from an air source 202, as described herein. The pressurized fluid may be understood to be air. The side inlet 104 may be configured to receive the pressurized fluid. The base plenum 102 may include a first end 108 and a second end 110 defining a channel 112 therebetween. The channel 112 may extend along a length (L1) of the air knife device 100 where the length (L1) may be equal to a length of the base plenum 102 from the first end 108 and the second end 110. The base plenum 102 may also be elongated and substantially polygonal in shape. The base plenum 102 may include a cross-section having a substantially square shape. The base plenum 102 may have a substantially rectangular shape overall. The base plenum 102 may also be defined by a first wall 101a, a second wall 101b, a third wall 101c, and a fourth wall 101d, each adjoining and connecting to form the base plenum 102 and the channel 112 inside the base plenum 102. In certain embodiments, the base plenum 102 may be substantially cylindrical in shape, rectangular, triangular, or any other suitable polygonal shape within the scope of the present disclosure. The base plenum 102 may also include a cross-section having a circular, oval, square, rectangular, hexagonal, or any other geometric shape. The walls 101a, 101b, 101c, and 101d of the base plenum 102 may also be straight, curved, or angled relative to one another to form the base plenum 102. The base plenum 102 may also be constructed from metal or any composite material. One of ordinary skill in the art may configure the base plenum 102 in any suitable configuration within the scope of the present disclosure.

The side inlet 104 of the base plenum 102 may be in fluid communication with the air source 202. The air source 202 may be coupled to the side inlet 104 for directing the pressurized fluid through the side inlet 104 of the base plenum 102. The side inlet 104 of the base plenum 102 may be configured in one of the first end 108 or the second end 110 for coupling to the air source 202 to direct the pressurized fluid through the channel 112 of the base plenum 102. The side inlet 104 may be configured in any shape or size to accommodate the first end 108 and the second end 110 of the base plenum for coupling thereto. This configuration may allow for efficient distribution of the pressurized fluid along the length (L1) of the base plenum 102 before entering a discharge chamber 106.

The discharge chamber 106 may be coupled to the base plenum 102 and in fluid communication with the base plenum 102. The discharge chamber 106 and the base plenum 102 may be equal in length to form the length (L1) of the air knife device 100. It should be appreciated that the length (L1) may be the length of the air knife device 100 such that the base plenum 102 and the discharge chamber have equal lengths to provide the uniform flow of the pressurized fluid through the air knife device 100.

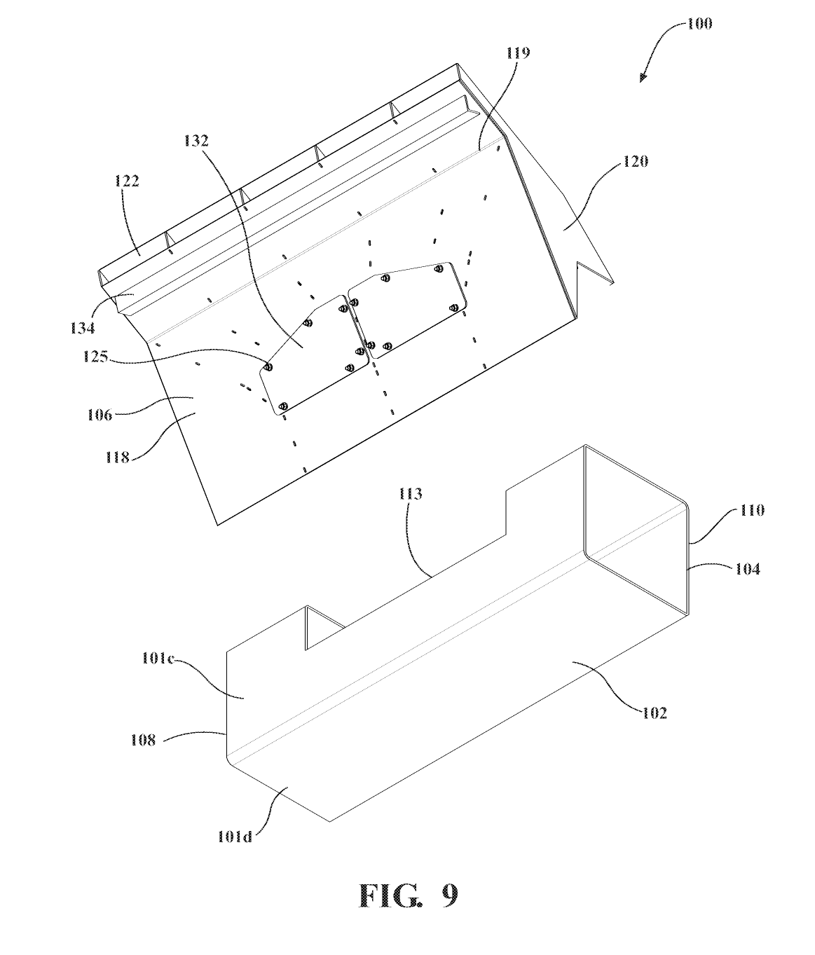

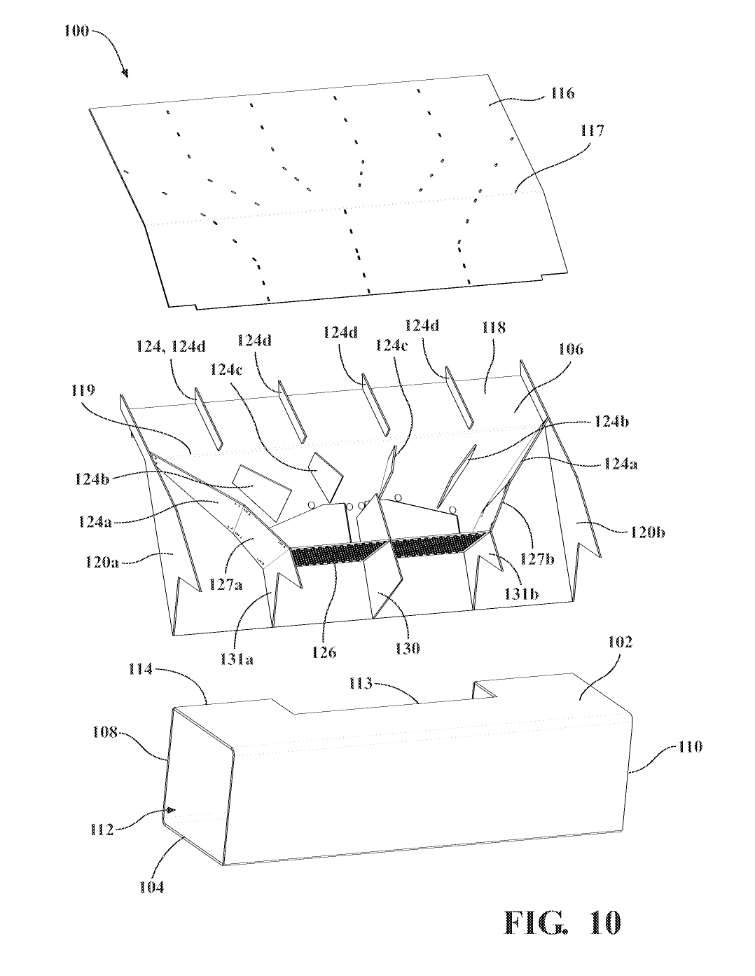

The discharge chamber 106 may extend laterally outward at an angle relative to the base plenum 102. The discharge chamber 106 may be positioned along an edge 114 of the base plenum 102, extending laterally outward at an angle relative to the edge 114 of the base plenum 102. The discharge chamber 106 may also be positioned between the second wall 101b and the third wall 101c of the base plenum 102. The discharge chamber 106 may intersect the base plenum 102 at the edge 114 thereof with a portion 115 of the discharge chamber 106 disposed in the channel 112 of the base plenum 102. More specifically, the base plenum 102 may include a recess 113 configured to receive the discharge chamber 106 for coupling thereto, as shown in FIG. 9. The recess 113 may be substantially polygonal in shape and may be formed through the base plenum 102 along the edge 114 of the base plenum 102 and between the second wall 101b and the third wall 101c of the base plenum 102. The recess 113 may allow the discharge chamber 106 to be coupled to the base plenum 102 and may allow the portion 115 of the discharge chamber 106 to be positioned in the channel 112. The edge 114 may connect each of the second wall 101b and the third wall 101c of the base plenum 102, with the recess 113 formed therebetween. This intersection may allow for direct fluid communication between the channel 112 of the base plenum 102 and the discharge chamber 106, facilitating the flow of pressurized fluid from the base plenum 102 into the discharge chamber 106.

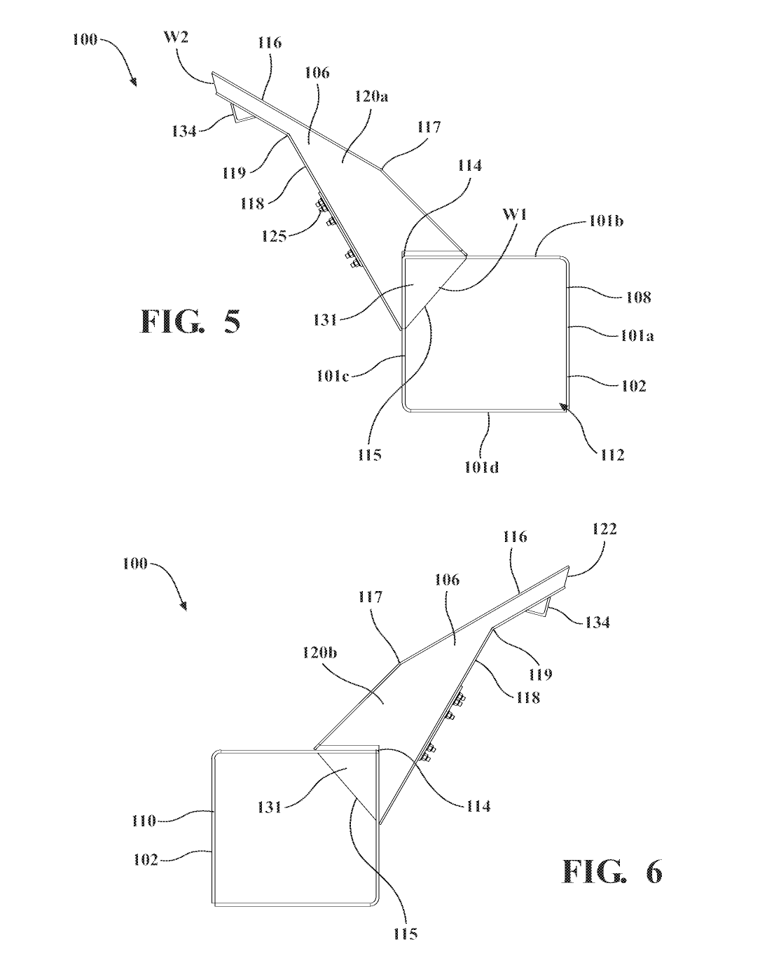

The discharge chamber 106 may include a first plate 116, a second plate 118, and a pair of sidewalls 120 coupling the first plate 116 to the second plate 118. The first plate 116, the second plate 118, and the pair of sidewalls 120 may be constructed from metal, aluminum, steel, or any other composite metal or rigid material within the scope of the present disclosure. The first plate 116 may include a first plate edge 117 extending across the first plate 116. The second plate 118 may also include a second plate edge 119 extending across the second plate 118. Each of the first plate edge 117 and the second plate edge 119 may extend across the length (L1) of the air knife device 100 and the length (L1) of the discharge chamber 106. The second plate 118 may be disposed opposite the first plate 116 with the pair of sidewalls 120 extending therebetween to define an interior of the discharge chamber 106. The first plate 116 and the second plate 118 may be angled upward relative to the edge 114 of the base plenum 102 and extend outward relative to the second wall 101b and the third wall 101c of the base plenum 102. The pair of sidewalls 120 may include a first sidewall 120a and a second sidewall 120b coupling the first plate 116 to the second plate 118 of the discharge chamber 106. The pair of sidewalls 120 may be disposed between the first plate 116 and the second plate 118 to form the discharge chamber 106. The first plate 116 and the second plate 118 may converge to form an air knife discharge portion 122 configured for release of the pressurized fluid therefrom. The first plate 116, the second plate 118, and the pair of sidewalls 120 may collectively form the discharge chamber 106 through which the pressurized fluid flows through and out the air knife discharge portion 122. The air knife discharge portion 122 may be understood to describe an outlet releasing the pressurized fluid from the air knife device 100. The converging configuration of discharge chamber 106 may include a first width (W1) measured from the first plate 116 to the second plate 118, as shown in FIG. 5. The first width (W1) may be understood to define a maximum width of the discharge chamber 106, as shown in FIG. 5. The discharge chamber 106 may also include a second width (W2) measured from the first plate 116 to the second plate 118 adjacent the air knife discharge portion 122. The second width (W2) of the discharge chamber 106 may be understood to define a minimum width of the discharge chamber 106, as shown in FIG. 5. The second width (W2) may be less than the first width (W1) to create the convergence between the first plate 116 and the second plate 118 to form the air knife discharge portion 122. This provides uniform pressurized fluid flow along the length (L1) of the air knife device 100 and across the width (W1, W2) of the discharge chamber 106 for consistent pressurized fluid flow.

The second plate 118 may have a plurality of fins 124 disposed thereon. The plurality of fins 124 may be configured to direct the pressurized fluid to the air knife discharge portion 122 for release therefrom. The plurality of fins 124 may be coupled to the second plate via a plurality of fasteners 125. The plurality of fasteners 125 may include screw fasteners 125 or any other suitable fastening means within the scope of the present disclosure. The fasteners 125 may allow for adjustability of the fin 124 positions during assembly or maintenance of the air knife device 100.

The fins 124 may be formed of a rigid material. For example, the fins 124 may be formed of metal including steel, stainless steel, aluminum, or any other suitable metal material within the scope of the present disclosure. Alternatively, the fins 124 may be formed of any rigid material such as hardened plastic, engineered plastic, high-performance polymers, polycarbonates, polyamides, polyoxymethane, ultra-High molecular weight polyethylene, polyether ketones, polytetrafluoroethylenes, and polyamide-imide thermoplastic (Torlon) and any other suitable material within the scope of the present disclosure. One of ordinary skill in the art may configure the fins 124 in any suitable material including rigid or flexible within the scope of the present disclosure.

The discharge chamber 106 may further include a mesh plate 126 having a plurality of apertures 128 disposed therethrough. The mesh plate 126 may be positioned between the base plenum 102 and the discharge chamber 106 to allow the pressurized fluid received from the base plenum 102 to be directed through the apertures 128 of the mesh plate 126 and towards the fins 124 in the discharge chamber 106 for exiting out of the air knife discharge portion 122. The mesh plate 126 may be disposed between the first plate 116, the second plate 118, and the pair of sidewalls 120. The mesh plate 126 may be relatively flat in configuration and may be disposed relatively above the edge 114 of the base plenum 102. The mesh plate 126 may be constructed from various materials including perforated metal, wire mesh, or any others suitable material. The mesh plate 126 may also be injection molded from plastic or any other suitable material with various porosity levels. The mesh plate 126 may also be removable or adjustable to allow for different configurations based on application requirements. One of ordinary skill in the art may select a suitable configuration for the mesh plate 126 within the scope of the present disclosure. The apertures 128 of the mesh plate 126 may be configured to distribute the pressurized fluid evenly across the length (L1) of the air knife device 100 for directing the pressurized fluid through the discharge chamber 106. The apertures 128 may assist in regulating the flow of pressurized fluid entering the discharge chamber 106. The apertures 128 may include a diameter between a range of 0.5 inches to 3 inches, for example. One of ordinary skill in the art may select a suitable diameter for the apertures 128 to regulate the flow of pressurized fluid through the mesh plate 126, where the larger the diameter, the more pressurized fluid may flow through the apertures 128. Desirably, this militates against a dead space or of increased pressure in one area of the base plenum 102 as the mesh plate 126 may reduce fluid pressure imbalances across the length (L1) of the air knife device 100 and particularly in the base plenum 102. Advantageously, the pressurized fluid may flow from the base plenum 102 and pass through the mesh plate 126 to be directed towards the air knife discharge portion 122.

The mesh plate 126 may include a first mesh plate 126a and a second mesh plate 126b. The first mesh plate 126a may be disposed adjacent the second mesh plate 126b or in longitudinal alignment with one another. The mesh plate 126 may include any number of mesh plates placed in a stacked or sequential relationship relative to one another where the pressurized fluid may flow therethrough to control the rate of the pressurized fluid. Each of the first mesh plate 126a and the second mesh plate 126b may include the apertures 128. Each aperture 128 of the plurality of apertures 128 may be substantially circular in shape and equal in size relative to one another, to allow a uniform distribution of the pressurized fluid through the apertures 128 of the mesh plate 126. The apertures 128 may be configured in any shape or size within the scope of the present disclosure to create different flow paths of the pressurized fluid. A spacing between each aperture 128 may also be uniform or varied to control the flow path of the pressurized fluid for optimization. The mesh plate 126 may function as a restricting baffle to direct or obstruct the flow of pressurized fluid to control a rate of the pressurized fluid through the discharge chamber 106 toward the air knife discharge portion 122.

The mesh plate 126 may be separated by a center plate 130 disposed perpendicular to the mesh plate 126 and through a center 129 of the mesh plate 126. More specifically, the center plate 130 may be disposed at the center 129 between the first mesh plate 126a and the second mesh plate 126b. The center plate 130 may intersect the mesh plate 126 at the center 129. This allows for symmetrical distribution of the pressurized fluid on either side of the center plate 130 through the first mesh plate 126a and the second mesh plate 126b. The center plate 130 may extend through the channel 112 of the base plenum 102 and may extend through the discharge chamber 106. The center plate 130 may be rectangular in shape. Alternatively, in certain embodiments, the mesh plate 126 may be separated by more than one center plate 130 configured to optimize the pressurized fluid flow rate through the mesh plate 126. The center plate 130 may also be positioned at different locations relative to the mesh plate 126. Each of the mesh plate 126 and the center plate 130 may incorporate additional flow control features such as raised sections, protrusions, channels, textured surfaces, smooth surfaces, and/or combinations thereof. One of ordinary skill in the art may select a suitable configuration for the center plate 130 within the scope of the present disclosure.

The center plate 130 may be disposed on an axis (A) formed centrally through the second plate 118 of the discharge chamber 106, which the center 129 of the mesh plate 126 also runs through. This axis (A) may run through the discharge chamber 106 and may serve as a reference point for the positioning and orientation of the plurality of fins 124 within the discharge chamber 106.

The plurality of fins 124 may be positioned symmetrically relative to the axis (A) that the center plate 130 is disposed on. This symmetrical arrangement may ensure balanced airflow and uniform distribution of the pressurized fluid exiting from the air knife discharge portion 122. The fins 124 may also create a diverging path of the airflow through the discharge chamber 106 to allow for uniform distribution of the pressurized fluid exiting the air knife discharge portion 122. The fins 124 may be configured to direct and manipulate the pressurized fluid flow path to direct the pressurized fluid towards the air knife discharge portion 122. The fins 124 may be arranged at an angle relative to the axis (A) and the center plate 130 disposed through the center 129 of the mesh plate 126. The angled arrangement may direct the pressurized fluid in a desired direction through the discharge chamber 106 and exits the air knife discharge portion 122. The plurality of fins 124 may include an outer fin 124a, a first inner fin 124b, and a second inner fin 124c. Each fin 124 may be positioned and angled relative to the axis (A) to optimize the flow characteristics of the pressurized fluid through the discharge chamber 106. The outer fin 124a, the first inner fin 124b, the second inner fin 124c, may each be disposed on either side of the center axis (A) such that this creates a symmetrical internal configuration of the discharge chamber 106. In particular, the second plate 118 of the discharge chamber 106 may include two outer fins 124a, two first inner fins 124b, two second inner fins 124c arranged on the second plate 118 of the discharge chamber 106 to direct the pressurized fluid through the discharge chamber.

The outer fin 124a may be disposed at an angle between a range of 43 to 45 degrees relative to the axis (A) that the center plate 130 is disposed on. The outer fin 124a may be disposed at an angle of 44.1 degrees relative to the axis (A). This angle may direct the pressurized fluid toward the air knife discharge portion 122. The first inner fin 124b may be disposed at an angle between a range of 47 to 49 degrees relative to the axis (A) that the center plate 130 is disposed on. The first inner fin 124b may be disposed at an angle of 48 degrees relative to the axis (A). The larger angle of the first inner fin 124b relative to the outer fin 124a may create a flow pattern that diverges the pressurized fluid as the pressurized fluid approaches the air knife discharge portion 122. The second inner fin 124c may be disposed at an angle between a range of 27 to 29 degrees relative to the axis (A) that the center plate 130 is disposed on. The second inner fin 124c may be disposed at an angle of 28 degrees relative to the axis (A). The smaller angle of the second inner fin 124c may provide additional flow control and may assist in directing the pressurized fluid toward the air knife discharge portion 122. One of ordinary skill in the art may select a suitable degree to dispose each of the fins 124 relative to the axis (A) within the scope of the present disclosure. Advantageously, the fins 124 may be arranged to create a diverging cross-sectional area to direct the pressurized fluid towards the air knife discharge portion 122, and the fins 124 may be configured to guide the pressurized fluid in a diverging path from the mesh plate 126 to the air knife discharge portion 122.

The plurality of fins 124 may also include upper fins 124d disposed proximately above the outer fins 124a, the first inner fins 124b, and the second inner fins 124c. The upper fins 124d may include four upper fins 124d each arranged on the second plate 118 above the outer fins 124a, the first inner fins 124b, and the second inner fins 124c. The four upper fins 124d may be parallel to one another. The four upper fins 124d may be equally spaced apart from one another. The four upper fins 124d may be spaced apart from the outer fins 124a, the first inner fins 124b, the second inner fins 124c by the second plate edge 119 of the second plate 118. The upper fins 124d may be disposed adjacent to the air knife discharge portion 122 to direct the pressurized fluid out therefrom. The converging configuration the first plate 116 with the second plate 118 allows the pressurized fluid to be directed out of the air knife discharge portion 122 in a uniform manner across the length (L1) of the air knife device 100, as the diverging configuration of the fins 124 across the second plate 118 allow the pressurized fluid to be evenly dispersed through the discharge chamber for directing out the air knife discharge portion 122.

The outer fins 124a, the first inner fins 124b, the second inner fins 124c, and the upper fins 124d may cooperate with one another to optimize the flow of the pressurized fluid through the air knife device 100. As shown in FIG. 15, the flow of the pressurized fluid may be directed from the side inlet 104 of the base plenum 102 and through the discharge chamber 106, out of the air knife discharge portion 122, with an even distribution across the length (L1) of the air knife device 100 and across the second width (W2) of the discharge chamber 106. As the air is directed through the mesh plate 126 and the fins 124, a velocity and pressure of the pressurized fluid may be controlled across the length (L1) of the air knife device 100, providing improved consistency of velocity and pressure. Desirably, this optimizes the functionality of the air knife device 100 for enhanced pressurized fluid distribution out of the air knife discharge portion 122.

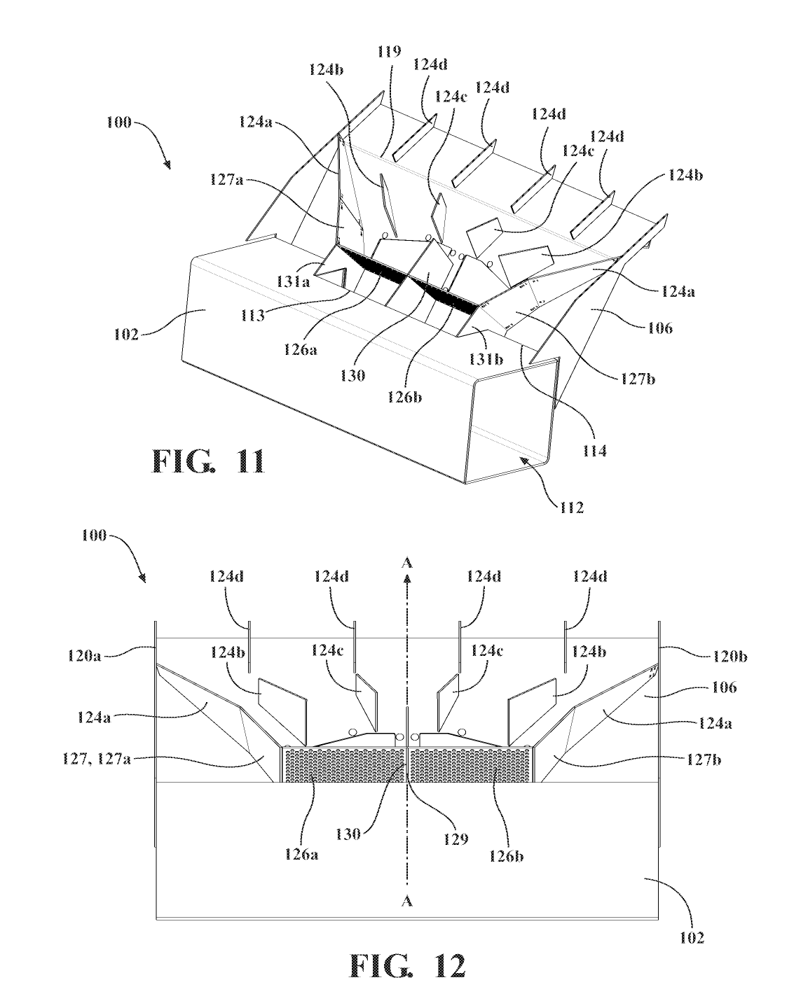

The outer fins 124a may also be coupled to internal fin walls 127. The internal fin walls 127 may include a first internal fin wall 127a and a second internal fin wall 127b. The first internal fin wall 127a may be coupled to the outer fins 124a to assist in positioning the outer fins 124a at the angle relative to the axis (A), as shown in FIG. 11. In certain embodiments, the first internal fin wall 127a and the second internal fin wall 127b may be disposed at an angle between a range of 35 to 38 degrees relative to the axis (A). The first internal fin wall 127a and the second internal fin wall 127b may be disposed at an angle of 36.5 degrees relative to the axis (A). The internal fin walls 127 may be disposed in the discharge chamber 106. The internal fin walls 127 may be coupled using the fasteners 125. The internal fin walls 127 may also be angled relative to the axis (A), as shown in FIG. 11. The internal fin walls 127 may also assist in directing the pressurized fluid through the discharge chamber 106 and towards the air knife discharge portion 122 as well as assists in facilitating uniform fluid flow across the converging path in the discharge chamber 106.

The internal fin walls 127 may be coupled to reinforcing walls 131 configured to allow the discharge chamber 106 to be coupled to the edge 114 of the base plenum 102 in the recess 113 of the base plenum 102 with a secure and leak-free seal to militate against the pressurized fluid from escaping when coupling of the base plenum 102 and the discharge chamber 106. Desirably, the reinforcing walls 131 may be arranged on either side of the center plate 130 coupled to each of the internal fin walls 127 in the discharge chamber 106. The reinforcing walls 131 may be geometric in shape. The reinforcing walls 131 may include a shape configured to accommodate dimensions and a shape of the base plenum 102. The reinforcing walls 131 may also accommodate dimensions and a shape of the recess 113 of the base plenum 102, which allows the discharge chamber 106 to be received therethrough for coupling to the base plenum 102 along the edge 114. As shown in FIGS. 5-6 and 10-11, the reinforcing walls 131 may include a first reinforcing wall 131a and a second reinforcing wall 131b where the center plate is disposed between. The reinforcing walls 131 may be configured to secure the connection between the discharge chamber 106 and the base plenum 102 and militate against the pressurized fluid from escaping the base plenum 102 to enhance the uniform fluid flow distribution across the air knife device 100.

In certain embodiments, the air knife device 100 may include removable access panels 132 formed on the second plate 118 of the discharge chamber 106. The removable access panels 132 may be coupled to the second plate 118 via the fasteners 125, allowing user access to the discharge chamber 106 to facilitate maintenance of the mesh plate 126, the center plate 130, or the fins 124. The removable access panels 132 may allow for cleaning of the air knife device 100, specifically the discharge chamber 106, as well as replacement of any component of the discharge chamber 106, and adjustment capabilities during operation. The air knife device 100 may also include a reinforcing bar 134 disposed on the second plate 118 between the second plate edge 119 and the air knife discharge portion 122. The reinforcing bar 134 may extend from the first sidewall 120a to the second sidewall 120b on the second plate 118 and may act as a structural reinforcement element.

As shown in FIGS. 15-16, the materials separating system 200 may include the air knife device 100, according to certain embodiments of the present disclosure. The materials separating system 200 may include the air knife device 100 as described herein, the air source 202, and a material separating machine 204. The air source 202 may be configured as a blower or any other air source 202 within the scope of the present disclosure for providing fluid communication with the air knife device 100. The material separating machine 204 may be a vibratory machine configured to separate a batch of materials. One of ordinary skill in the art may select any suitable material separating machine 204 to couple with the air knife device 100 within the scope of the present disclosure.

The air source 202 may include a blower 202 configured to release pressurized fluid therefrom. The blower 202 may be coupled to the side inlet 104 of the base plenum 102 of the air knife device 100 to provide a continuous supply of pressurized fluid during operation. The material separating machine 204 may be configured to receive a batch of mixed materials for separation thereof. The batch of mixed materials may include materials of different weights, densities, or other physical characteristics that allow for separation when subjected to pressurized fluid. The material separating machine 204 may be in fluid communication with the blower 202 and the blower 202 may be configured to direct the pressurized fluid through the air knife device 100. The pressurized fluid exiting the air knife device 100 may be in fluid communication with an incoming adjacent flow of the batch of mixed materials from the materials separating machine 204, for example. In certain embodiments, as a non-limiting example, the batch of mixed materials may enter through an inlet of the materials separating machine 204 and may be dropped directly in front of the air knife discharge portion 122 of the air knife device 100 releasing the pressurized fluid. The pressurized fluid may be configured to exit the air knife discharge portion 122 of the air knife device 100 to separate the batch of mixed materials received from the material separating machine 204 where materials having larger or heavier densities subjected to the pressurized fluid may fall directly into a collection bin beneath the air knife device 100 and materials having smaller or lighter densities subjected to the pressurized fluid may be blown outwardly relative to the air knife device 100 into another collection bin. One of ordinary skill in the art may select a suitable configuration for the materials separating system 200 for fluid communication between the air knife device 100, the air source 202, and the material separating machine 204 within the scope of the present disclosure.

In operation, the pressurized fluid may flow from the air source 202 through the side inlet 104 into the channel 112 of the base plenum 102. The pressurized fluid may travel through the channel 112 and enter the discharge chamber 106 through the mesh plate 126. As the pressurized fluid passes through the plurality of apertures 128 of the mesh plate 126, the pressurized fluid may be distributed evenly across the length (L1) of the air knife device 100, and across the second width (W2) of the discharge chamber 106. The center plate 130 may assist in directing the flow symmetrically on both sides of the axis (A) which the center plate 130 is disposed on. The pressurized fluid may flow past the plurality of fins 124, which may direct the pressurized fluid flow toward the air knife discharge portion 122. The angled arrangement of the outer fin 124a, the first inner fin 124b, and the second inner fin 124c may create a converging flow pattern that concentrates the pressurized fluid as the pressurized fluid approaches the air knife discharge portion 122. The first plate 116 and the second plate 118 may converge to form the air knife discharge portion 122 through which the pressurized fluid is released at high velocity. The high-velocity pressurized fluid exiting the air knife discharge portion 122 may be directed toward the batch of mixed materials. The force of the pressurized fluid may separate lighter materials from heavier materials based on the physical characteristics. The lighter materials may be displaced by the pressurized fluid while the heavier materials remain relatively unaffected, thereby achieving separation of the mixed materials.

In certain embodiments, the materials separating system 200 may be used to separate a batch of mixed recyclable materials including lightweight plastic films, heavier plastic bottles, and metal cans. The batch of mixed materials may be fed onto the material separating machine 204, which may vibrate to present the materials in a distributed manner. The air source 202 may generate pressurized fluid at a desired pressure optimal enough to displace lighter materials from heavier materials. As the pressurized fluid exits the air knife discharge portion 122 of the air knife device 100, the uniform pressurized fluid stream may impact the mixed materials. The lightweight plastic films, having lower mass and greater surface area, may be immediately lifted and carried away from the material separating machine 204 by the force of the pressurized fluid. The heavier plastic bottles may be partially displaced or tumbled by the pressurized fluid, separating into a collection zone. The metal cans, having the greatest density and mass, may remain substantially on the material separating machine 204 or fall into another collection zone designated for heavier materials. The symmetrical internal configuration of the fins 124 and the mesh plate 126 may ensure consistent pressurized fluid distribution across the air knife device 100, thereby achieving uniform separation efficiency.

As shown in FIG. 17, a method 300 of separating materials may include a step 302 of providing the materials separating system 200 as described herein. The method 300 may include a step 304 of coupling the air source 202 to the side inlet 104 of the base plenum 102 to establish fluid communication between the air source 202 and the base plenum 102. The method 300 may further include a step 306 of distributing the pressurized fluid through the discharge chamber 106 by allowing the pressurized fluid to flow from the base plenum 102, through the mesh plate 126, and past the fins 124. The method 300 may include a step 308 of releasing the pressurized fluid from the air knife discharge portion 122 for separating the batch of mixed materials. The released pressurized fluid may impact the mixed materials to effectuate separation based on the physical characteristics of the materials.

Advantageously, the air knife device 100 may provide enhanced pressurized fluid flow and consistent flow across the length (L1) of the air knife device 100 through the symmetrical internal configuration of the fins 124 on the second plate 118. The air knife device 100 may manage pressurized fluid distribution from the side inlet 104 to reduce pressure imbalances as the mesh plate 126 may act as a restricting baffle to control the flow of the pressurized fluid to the discharge chamber 106. The air knife device 100 may provide uniform air flow patterns and may optimize the channel 112 of the base plenum 102 for more consistent discharging of pressurized fluid flow. Desirably, the materials separating system 200 may include enhanced uniform air flow distribution using the air knife device 100 to separate a batch of materials having different densities, weights, and/or physical characteristics.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. An air knife device comprising:
a base plenum having a side inlet configured to receive pressurized fluid from an air source coupled thereto; and
a discharge chamber coupled to the base plenum and in fluid communication with the base plenum, the discharge chamber including a first plate, a second plate having a plurality of fins disposed thereon, and a pair of sidewalls coupling the first plate to the second plate, the first plate and the second plate converge to form an air knife discharge portion where the plurality of fins direct the pressurized fluid to the air knife discharge portion for release therefrom.

2. The air knife device of claim 1, wherein the base plenum includes a first end and a second end defining a channel.

3. The air knife device of claim 2, wherein the side inlet of the base plenum is configured in one of the first end or the second end to direct the pressurized fluid through the channel of the base plenum.

4. The air knife device of claim 3, wherein the discharge chamber is positioned along an edge of the base plenum.

5. The air knife device of claim 4, wherein the discharge chamber intersects the base plenum at the edge thereof with a portion of the discharge chamber disposed in the channel of the base plenum.

6. The air knife device of claim 1, wherein the discharge chamber further includes a mesh plate having a plurality of apertures disposed therethrough.

7. The air knife device of claim 6, wherein the mesh plate is positioned between the base plenum and the discharge chamber to allow the pressurized fluid received from the base plenum to be directed through the plurality of apertures of the mesh plate and towards the plurality of fins in the discharge chamber for exiting out of the air knife discharge portion.

8. The air knife device of claim 7, wherein the mesh plate includes a first mesh plate and a second mesh plate separated by a center plate disposed perpendicular thereto, the center plate disposed through a center between the first mesh plate and the second mesh plate.

9. The air knife device of claim 8, wherein the center plate is disposed on an axis formed centrally through the second plate.

10. The air knife device of claim 9, wherein the plurality of fins is positioned symmetrically relative to the axis that the center plate is disposed on.

11. The air knife device of claim 10, wherein each fin of the plurality of fins is arranged at an angle relative to the center plate of the mesh plate.

12. The air knife device of claim 11, wherein the plurality of fins includes an outer fin, a first inner fin, and a second inner fin.

13. The air knife device of claim 12, wherein the outer fin is disposed at an angle between a range of 43 to 45 angles relative to the axis that the center plate is disposed on.

14. The air knife device of claim 12, wherein the first inner fin is disposed at an angle between a range of 47 to 49 degrees relative to the axis that the center plate is disposed on.

15. The air knife device of claim 12, wherein the second inner fin is disposed at an angle between a range of 27 to 29 degrees relative to the axis that the center plate is disposed on.

16. The air knife device of claim 1, wherein the second plate is disposed opposite the first plate.

17. The air knife device of claim 1, wherein the plurality of fins is coupled to the second plate via a plurality of fasteners, the plurality of fasteners including a screw fastener.

18. The air knife device of claim 1, wherein:
the base plenum includes a first end and a second end defining a channel,
the side inlet of the base plenum is configured in one of the first end or the second end to direct the pressurized fluid through the channel of the base plenum,
the discharge chamber is positioned along an edge of the base plenum,
the discharge chamber intersects the base plenum at the edge thereof with a portion of the discharge chamber disposed in the channel of the base plenum,
the discharge chamber further includes a mesh plate having a plurality of apertures disposed therethrough,
the mesh plate is positioned between the base plenum and the discharge chamber to allow the pressurized fluid received from the base plenum to be directed through the plurality of apertures of the mesh plate and towards the plurality of fins in the discharge chamber for exiting out of the air knife discharge portion,
the mesh plate includes a first mesh plate and a second mesh plate separated by a center plate disposed perpendicular thereto, the center plate disposed through a center between the first mesh plate and the second mesh plate,
the center plate is disposed on an axis formed centrally through the second plate,
the plurality of fins is positioned symmetrically relative to the axis that the center plate is disposed on,
each fin of the plurality of fins is arranged at an angle relative to the center plate of the mesh plate,
the plurality of fins includes an outer fin, a first inner fin, and a second inner fin,
the outer fin is disposed at an angle between a range of 43 to 45 angles relative to the axis that the center plate is disposed on,
the first inner fin is disposed at an angle between a range of 47 to 49 degrees relative to the axis that the center plate is disposed on,
the second inner fin is disposed at an angle between a range of 27 to 29 degrees relative to the axis that the center plate is disposed on,
the second plate is disposed opposite the first plate, and
the plurality of fins is coupled to the second plate via a plurality of fasteners, the plurality of fasteners including a screw fastener.

19. A materials separating system comprising:
an air knife device including:
a base plenum having a side inlet configured to receive pressurized fluid from an air source coupled thereto; and
a discharge chamber coupled to the base plenum and in fluid communication with the base plenum, the discharge chamber including a first plate, a second plate having a plurality of fins disposed thereon, and a pair of sidewalls coupling the first plate to the second plate, the first plate and the second plate converge to form an air knife discharge portion where the plurality of fins direct the pressurized fluid to the air knife discharge portion for release therefrom;
an air source including a blower configured to release pressurized fluid therefrom, the blower coupled to the side inlet of the base plenum of the air knife device; and
a material separating machine configured to receive a batch of mixed materials for separation thereof, the material separating machine in fluid communication with the blower, the blower configured to direct the pressurized fluid through the air knife device, wherein the pressurized fluid is configured to exit the air knife discharge portion of the air knife device to separate the batch of mixed materials received from the material separating machine.

20. A method of separating materials comprising:
providing a materials separating system including:
an air knife device including:
a base plenum having a side inlet configured to receive pressurized fluid from an air source coupled thereto, and
a discharge chamber coupled to the base plenum and in fluid communication with the base plenum, the discharge chamber including a first plate, a second plate having a plurality of fins disposed thereon, and a pair of sidewalls coupling the first plate to the second plate, the first plate and the second plate converge to form an air knife discharge portion where the plurality of fins direct the pressurized fluid to the air knife discharge portion for release therefrom,
an air source including a blower configured to release pressurized fluid therefrom, the blower coupled to the side inlet of the base plenum of the air knife device; and
a material separating machine configured to receive a batch of mixed materials for separation thereof, the material separating machine in fluid communication with the blower to direct the pressurized fluid through the air knife device, wherein the pressurized fluid is configured to exit the air knife discharge portion of the air knife device to separate the batch of mixed materials received from the material separating machine;
coupling the air source to the side inlet of the base plenum;
distributing the pressurized fluid through the discharge chamber; and
releasing the pressurized fluid from the air knife discharge portion for separating the batch of mixed materials.
